(19) United States
(12) Patent Application Publication
(10) Pub. No.: US 2026/0300488 A1
(43) Pub. Date: Oct. 1, 2026

(54) DETERMINING SAMPLING FREQUENCY OF INPUT/OUTPUT (I/O) REQUESTS FOR RANSOMWARE DETECTION IN COMPUTATIONAL STORAGE SYSTEMS

(71) Applicant: INTERNATIONAL BUSINESS MACHINES CORPORATION, Armonk, NY (US)

(72) Inventors: Roman Alexander Pletka, Uster (CH); Dionysios Diamantopoulos, Zurich (CH); Charalampos Pozidis, Thalwil (CH); Yves Alexandre Beraldo dos Santos, Marana, AZ (US); Andrew D. Walls, San Jose, CA (US)

(21) Appl. No.: 19/095,969

(22) Filed: Mar. 31, 2025

(51) Int. Cl. G06F 21/56; G06F 21/55; G06N 20/20

(52) U.S. Cl. CPC G06F 21/566; G06F 21/552; G06N 20/20

(57) ABSTRACT

In some embodiments, a method to determine a sampling frequency of input/output (I/O) requests for ransomware detection in a computational storage device (CSD). The method can comprise receiving, from a computational storage device (CSD), a plurality of features and a sampling rate, the plurality of features extracted from a plurality of I/O requests sampled by the CSD using the sampling rate. The method can further comprise providing the sample rate and the plurality of sampled I/O operations to a plurality of machine learning (ML) models. Each ML model can be trained on a training dataset comprising a plurality of training sampled operations, and a training sampling rate. The method can further comprise receiving, from each of the plurality of ML models, a compatibility metric associated with the training sampling rate of that ML model.

### BACKGROUND

Ransomware is a type of malware that infects a computer system, encrypts a user's data on that system, and then attempts to extract a ransom from that user in exchange for a decryption key.

### BRIEF SUMMARY

In some embodiments, a method to determine a sampling frequency of input/output (I/O) requests for ransomware detection in a computational storage device (CSD). The method can comprise receiving, from a computational storage device (CSD), a plurality of features and a sampling rate, the plurality of features extracted from a plurality of I/O requests sampled by the CSD using the sampling rate. The method can further comprise providing the sample rate and the plurality of sampled I/O operations to a plurality of machine learning (ML) models. Each ML model can be trained on a training dataset comprising a plurality of training sampled operations and a training sampling rate. The method can further comprise receiving, from each of the plurality of ML models, a compatibility metric associated with the training sampling rate of that ML model. The method can further comprise selecting a highest compatibility metric from the plurality of compatibility metrics received from the plurality of ML models. The method can further comprise updating the sampling rate to be the training sampling rate associated with the compatibility metric. In some embodiments, an accuracy metric of the model can comprise an F1 score. In some embodiments, the F1 score can comprise a harmonic mean of Precision and Recall.

In some embodiments, the method can comprise sampling, by the CSD, the plurality of I/O operations using the updated sampling rate, thereby providing a second plurality of sampled I/O operations. In some embodiments, the method can further comprise extracting features from the second plurality of sampled I/O operations. In some embodiments, the method can further comprise detecting a prediction of ransomware based on the extracted features.

In some embodiments, the training sampling rate of each ML model is a range of sampling rates.

In some embodiments, each ML model of the plurality of ML models is associated with a CSD or a storage volume.

In some embodiments, each of the plurality of ML models is further trained based on a workload of the CSD.

In some embodiments, a system can comprise a computing node comprising a computer readable storage medium having program instructions embodied therewith. The program instructions can be executable by a processor of the computing node to cause the processor to perform a method. The method executed by the processor can receiving, from a computational storage device (CSD), a plurality of features and a sampling rate, the plurality of features extracted from a plurality of I/O requests sampled by the CSD using the sampling rate. The method executed by the processor can further comprise providing the sampling rate and the plurality of sampled I/O operations to a plurality of machine learning (ML) models. Each ML model can be trained on a training dataset comprising a plurality of training sampled operations, and a training sampling rate. The method executed by the processor can further comprise receiving, from each of the plurality of ML models, a compatibility metric associated with the training sampling rate of that ML model. The method executed by the processor can further comprise selecting a highest compatibility metric from the plurality of compatibility metrics received from the plurality of ML models. The method executed by the processor can further comprise providing, to the CSD, the sampling rate associated with the compatibility metric.

In some embodiments, the method executed by the processor further comprises sampling, by the CSD, the plurality of I/O operations using the updated sampling rate, thereby providing a second plurality of sampled I/O operations. In some embodiments, the method executed by the processor further comprises extracting features from the second plurality of sampled I/O operations. In some embodiments, the method executed by the processor further comprises providing the extracted features to an inference engine to generate a prediction of ransomware based on the extracted features.

In some embodiments, the training sampling rate of each ML model is a range of sampling rates.

In some embodiments, each ML model of the plurality of ML model is associated with a CSD or a storage volume.

In some embodiments, each of the plurality of ML models is further trained based on a workload of the CSD.

In some embodiments, a computer program product for sampling data at a storage system can comprising a computer readable storage medium having program instructions embodied therewith. The program instructions can be executable by a storage system to cause the storage system to perform a method comprising receiving, from a computational storage device (CSD), a plurality of features and a sampling rate, the plurality of features extracted from a plurality of I/O requests sampled by the CSD using the sampling rate. The method executed by the storage system can further comprise providing the sampling rate and the first plurality of sampled I/O operations to a plurality of machine learning (ML) models. Each ML model can be trained on a training dataset comprising a plurality of training sampled operations and a training sampling rate. The method executed by the storage system can further comprise receiving, from each of the plurality of ML models, an compatibility metric associated with the training sampling rate of that ML model. The method executed by the storage controller can further comprise selecting a model with the highest compatibility metric from the plurality of compatibility metrics received from the plurality of ML models. The method executed by the storage system can further comprise updating the sampling rate to be the training sampling rate associated with the compatibility metric.

In some embodiments, the method executed by the storage system can further comprise sampling, by the CSD, the plurality of I/O operations using the updated sampling rate, thereby providing a second plurality of sampled I/O operations. In some embodiments, the method executed by the storage system further comprises extracting features from the second plurality of sampled I/O operations.

In some embodiments, the method executed by the storage system further comprises detecting a prediction of ransomware based on the extracted features.

In some embodiments, the training sampling rate of each ML model is a range of sampling rates.

In some embodiments, each ML model of the plurality of ML model is associated with a CSD or a storage volume.

In some embodiments, each of the plurality of ML models is further trained based on a workload of the CSD.

### BRIEF DESCRIPTION OF THE SEVERAL VIEWS OF THE DRAWINGS

FIG. 1A is a diagram illustrating a computational storage device operationally coupled with a host system according to embodiments of the present disclosure.

FIG. 1B is a block diagram 150 of an All-Flash Array 172 according to embodiments of the present disclosure.

FIG. 2 is a block diagram illustrating the CSD according to embodiments of the present disclosure.

FIG. 3 is a block diagram illustrating a computational storage device sampling from an I/O stream to train a machine learning model according to embodiments of the present disclosure.

FIG. 4A is a block diagram illustrating a computational storage device sampling from an I/O stream to use multiple trained machine learning models according to embodiments of the present disclosure.

FIG. 4B is a block diagram illustrating a computational storage device sampling from an I/O stream to train and use multiple trained machine learning models according to embodiments of the present disclosure.

FIG. 5A is a diagram illustrating an example of sequential sampling according to embodiments of the present disclosure.

FIG. 5B is a diagram illustrating an example of random sampling according to embodiments of the present disclosure.

FIG. 5C is a diagram illustrating an example of sequential-chunk sampling according to embodiments of the present disclosure.

FIG. 5D is a diagram illustrating an example of random-chunk sampling according to embodiments of the present disclosure.

FIG. 5E is a diagram illustrating an example of I/O-aware sampling according to embodiments of the present disclosure.

FIG. 6 is a block diagram illustrating an example embodiment of a computational storage device to determine optimal sampling frequency of I/O request for ransomware detection according to embodiments of the present disclosure.

FIG. 7 is a flow diagram illustrating a process of adjusting a sampling rate at a CSD according to embodiments of the present disclosure.

FIG. 8A is a graph illustrating F1 scores of a model trained without sampling using an inference on a test set with a varying sampling rate according to embodiments of the present disclosure.

FIG. 8B is a graph illustrating F1 scores of a model and testing data that use the same sampling rate according to embodiments of the present disclosure.

FIG. 8C is a graph illustrating F1 scores of a model trained with a fixed sampling rate and an inference on test set with varying sampling rate according to embodiments of the present disclosure.

FIG. 9 is a schematic of a computing node according to embodiments of the present disclosure.

### DETAILED DESCRIPTION

In some embodiments, a method and corresponding system provides an optimal sampling rate and an optimal sampling technique for a CSD performing I/O operations. One example of such operations is feature extraction for ransomware detection. The method trains at least one machine-learning model on the sampled data to detect ransomware, and the at least one model can evaluate (e.g., infer) different sampling rates (e.g., effectiveness at detecting ransomware at each sampling rate for each volume). In some embodiments, the method can iterate between training the model and using the model, thereby updating the training data and retraining the model using that updated training data. In some embodiments, the machine-learning model can include decision tree ensembles such as Random Forest, Gradient Boosting, XGBoost models, or time series classifiers such as LSTM, Hydra, or InceptionTime.

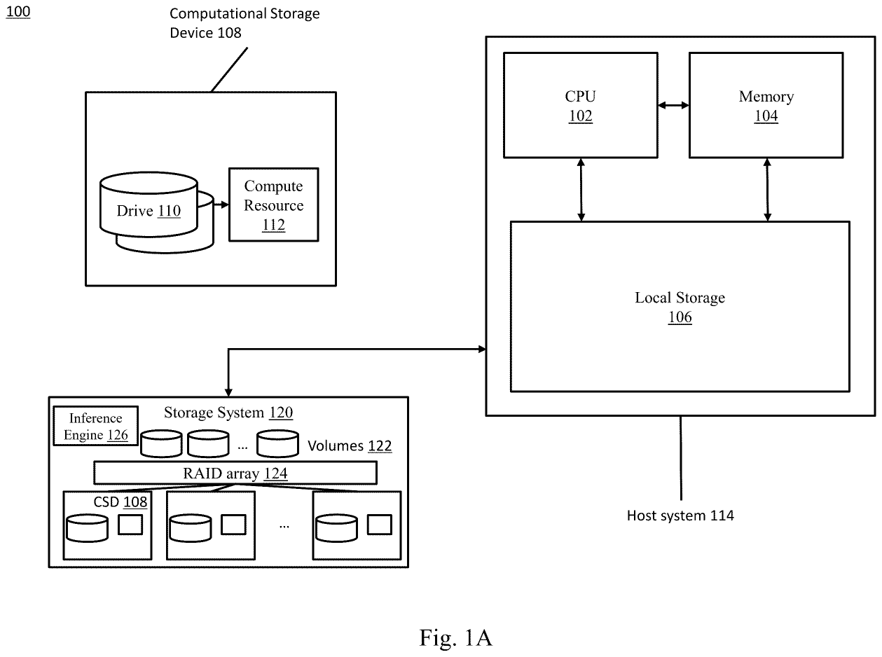

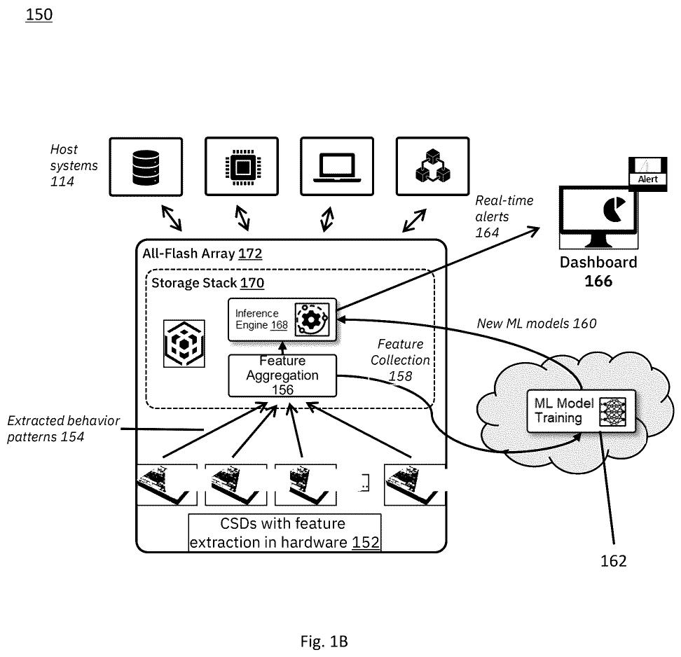

FIG. 1A is a diagram 100 illustrating a computational storage device 108 operationally coupled with a host system 114 according to embodiments of the present disclosure. The host system 114 can comprise a central processing unit (CPU) 102, a memory 104, and local storage 106. The CPU 102 can load data from the local storage 106 or memory 104 and perform various operations. However, the host system 114 can be constrained by the amount of storage available in local storage 106 and the amount of processing available with its CPU 102. The host system 114 be operatively connected to a storage system 120, which solves both problems.

A computational storage device (CSD) 108 comprises a drive 110 (e.g., a solid state drive (SSD), a hard disk drive (HDD), a tape drive, etc.) or other storage device, and a compute resource 112 (e.g., a CPU, a data processing unit (DPU), Application Specific Integrated Circuit (ASIC), Field Programmable Gate Array (FPGA), etc.). The compute resource 112 can perform operations on data stored on, being loaded from, or being written to, the drive 110. In such a way, the host system 114 can offload processing operations to the computational storage device 108. These processing operations can include encryption, decryption, indexing, searching, feature extraction, ransomware detection, etc. In some embodiments, it can be recognized that drive 110, as illustrated by FIGS. 1-4C and 6 can be one drive or multiple drives (e.g., an array of drives, such as a RAID array).

In some embodiments, a storage system 120 can include a plurality of volumes 122, an inference engine 126, a RAID array 124, and a plurality of CSDs 108 that form the RAID array 124. In some embodiments, the CSDs 108 can perform feature extraction, and the inference engine 126 can determine a sampling rate for feature extraction based on machine-learning models, as described further below. In some embodiments, if the compute resource 112 of each CSD 108 had enough capacity, it could also be used to determine the sampling rate for feature extraction or running an inference engine.

FIG. 1B is a block diagram 150 of an All-Flash Array 172 according to embodiments of the present disclosure. The All-Flash Array 172 includes a plurality of CSDs 152 that each have the capability to perform feature extraction from I/O operations with their hardware. A storage stack 170 can perform feature aggregation 156, direct a cloud resource to train a machine learning model 162 with the collected features 158, and output those models 160 to an inference engine 168. In some embodiments, the models 160 are specific to a particular system. Then, the inference engine 168 can output real-time alerts 164 by running inference on features using the ML models 160, such as the presence of ransomware. In some embodiments, CSDs, such as CSDs 152, in storage systems, such as an all-flash array 172 can be used to as part of one or more RAID arrays. The storage system stack can then provisions volumes 122 from the RAID array 124 as illustrated by FIG. 1A. Therefore, data for a volume can be distributed over multiple CSDs in a RAID array. Each CSD can further store data for multiple volumes. In some embodiments, the CSD separates I/O for different volumes to extract per-volume features and inference is executed for each volume.

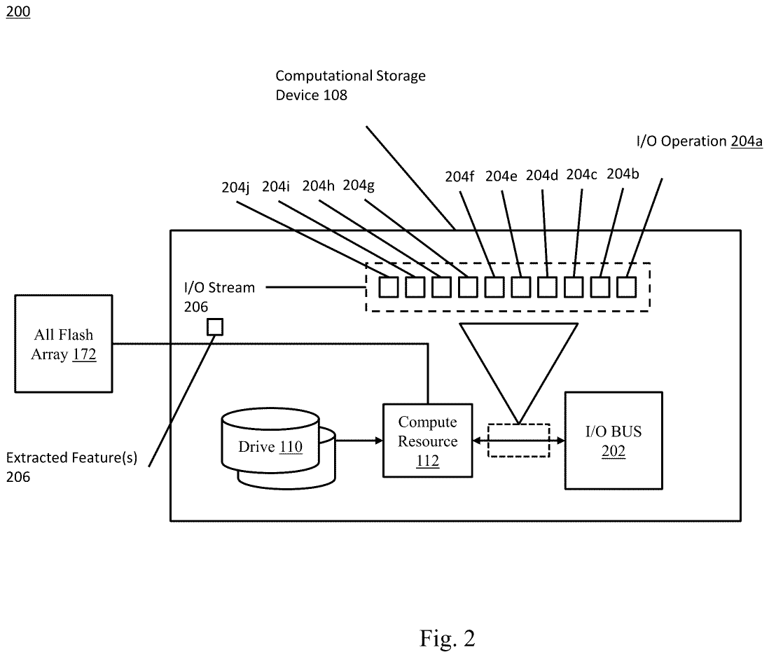

FIG. 2 is a block diagram 200 illustrating the CSD 108 according to embodiments of the present disclosure. It can be appreciated that the CSD 108 can be operatively coupled to one or more host systems, such as the host system 114 of FIG. 1A. In relation to FIG. 2, in some embodiments, storage systems (e.g., server farms, etc.) having one or more CSDs 108 can perform ransomware detection at the CSDs. In some embodiments, this saves processing power of the CPU 102 of a host system operatively coupled with the CSD 108. To perform ransomware detection, the CSDs 108 collect features (e.g., implement feature collection). The CSDs 108 therefore can extract features from I/O operations 204a-j of an I/O stream 206 received from or sent to an I/O bus 202. The I/O operations 204a-j are operations that cause processing to occur at the compute resource 112 of the CSD 108. In some embodiments, the I/O operations 204a-j cause the compute resource 112 to extract features 206 from the I/O stream 206. In some embodiments, the extracted features 206 can be used to detect ransomware. The extracted features 206 can then be sent to a layer of the all flash array 172 for further processing. The all flash array 172 can further aggregate features (e.g., perform feature aggregation). In some embodiments, the all flash array 172 can extract or aggregate features 206 from I/O operations 204a-j based on time intervals.

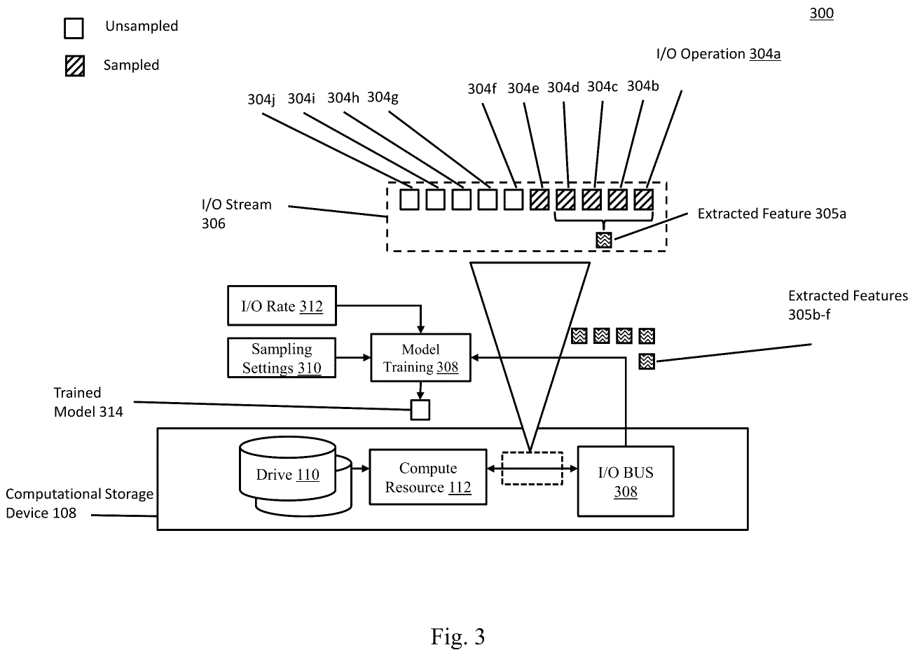

FIG. 3 is a block diagram 300 illustrating a computational storage device 108 sampling from an I/O stream 306 to train a machine learning model or perform inference using a machine learning model according to embodiments of the present disclosure. When I/O operations 204a-j are sampled (e.g., collected) at a same rate as the I/O operations (e.g., file operations, real-time file operations) are received, the volume of data may be too high to be able to process using the finite processing power of the Compute Resource 112. In some embodiments, the compute resource 112 of the CSD 108 samples I/O operations from the I/O Stream 306 when there is a high I/O rate, thereby providing a set of sampled I/O operations 304a-e. In some embodiments, the compute resource 112 samples the I/O Operations 304a-304j using a sampling rate and sampling method of sampling settings 310. In some embodiments, the sampled I/O operations 304a-304j can comprise extracted features. Therefore, the machine learning model can be trained on those extracted features and feature vectors formed from those extracted features. In some embodiments, the feature vectors can be extracted from I/O operations and/or additional volume information such as the current file-system type used. In some embodiments, feature information extracted from I/O operations can be counts, means (e.g., average mean), or any sort of statistics (e.g., 1st order moments, 2nd order moments, histograms, etc.) over a fixed time period. Within this fixed time period, the IO operations that are used to extract the statistics can be sampled. In some embodiments, the feature information from multiple CSDs is aggregated and grouped by volume (e.g., volumes 122 of the RAID array of FIG. 1A).

In some embodiments, the training is performed by a machine learning training computer or cloud entity. In some embodiments, the training can be performed by a processing entity of the CSD or storage system.

It can be recognized that in some embodiments, the CSD 108 includes a compute resource that performs the sampling in a similar manner. In FIGS. 3-5E, features extracted from sampled operations are illustrated as chevron-patterned blocks, while sampled operations are illustrated as striped blocks and unsampled operations are illustrated as blank boxes.

The compute resource 112 can sample the I/O operations 304a-j from the I/O Stream 306 and extract features 305a-f from the I/O stream 306 in time intervals. In some embodiments, the compute resource 112 provides the plurality of features 305a-f extracted from the sampled I/O operations and sampling settings 310 to a model training module 308 (e.g., a cloud based model training module 308). The model training module 308 splits the feature vectors 305a-f extracted on time intervals of the sampled I/O operations 304a-e into a training and a test set. The training set is used to train the model and the test set is used to determine the accuracy of the model. Sampling of IO operations and requests can be performed before the extraction of feature vectors for the training and the test sets. Further, sampling could also be additionally or exclusively performed on extracted feature vectors. For a given sampling rate used in training, the model's accuracy (e.g., accuracy at detecting ransomware using the extracted features) can be evaluated using the same or different sampling rates for the test set resulting in accuracy values for each pair. These accuracy values can be used later to determine a model for a current sampling rate in inference.

To build reasonable training and test data sets a wide range of workloads including benign workloads such as email-server, web server, fileserver, database, backup, or OLTP workloads and workloads with real or emulated ransomware activities executed on hosts attached to the storage system to collect feature information from computational storage devices. When the computational storage devices provide extracted feature information, the set of workloads can be executed for various configurations of sampling settings with different sampling rates. Alternatively, information from I/O operations can be collected from the workloads to generate a set of traces. Different sampling rates can then be used to extract feature information from these traces without need to re-run the workloads.

For example, a set of workloads can be run multiple times, where each time a different sampling is configured rate to get the necessary training data. For training, I/O operations or information can be directly collected into a trace files for a set of workloads. The same trace files can then be processed offline using different sampling rates to determine a ground truth to train the machine-learning models.

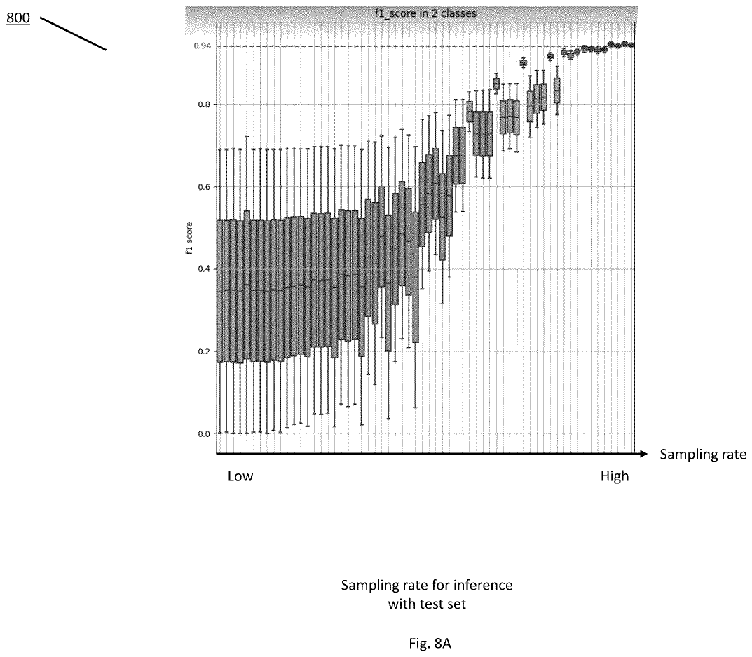

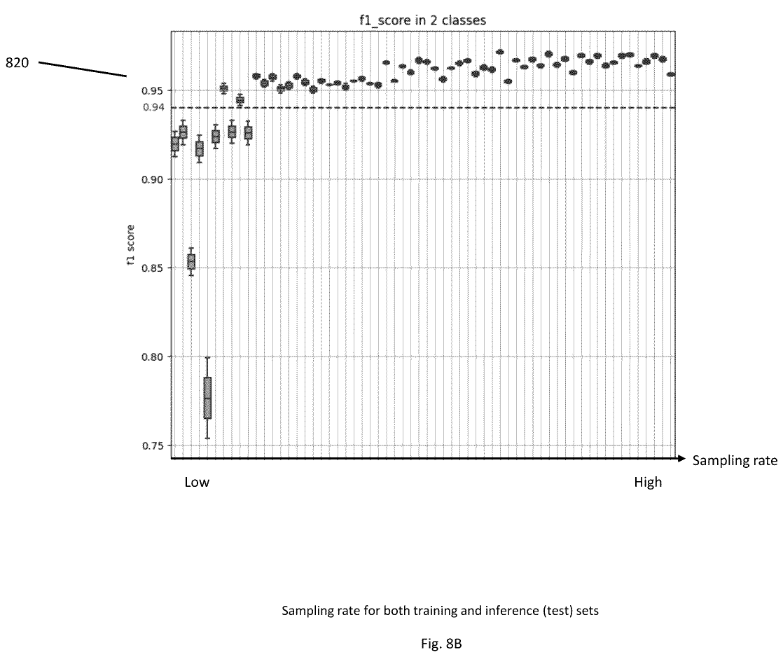

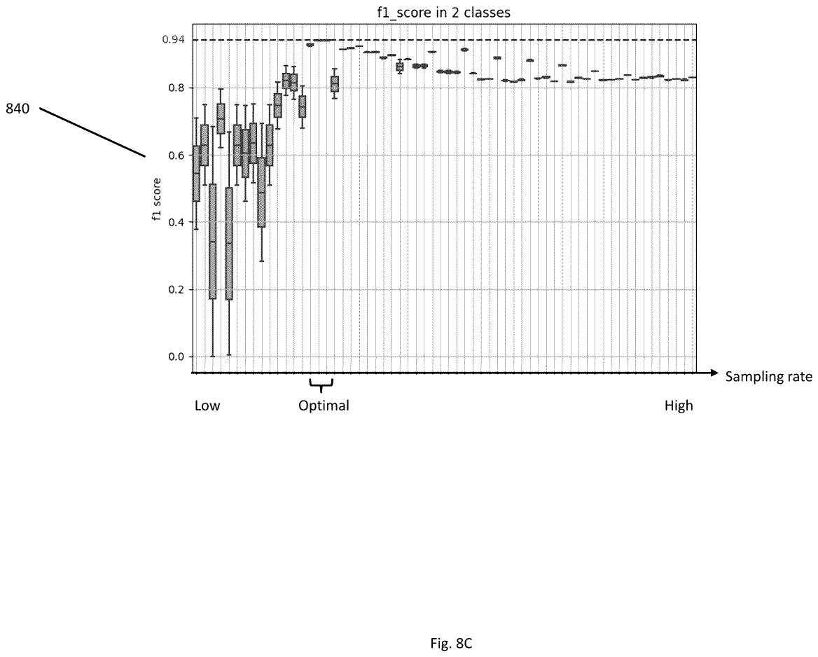

In some embodiments, models are trained with different sampling frequencies/sampling rates. Those models are evaluated against a test data set (e.g., the ground truth) to determine the accuracy. This is performed for a range of sampling rates used to evaluate the test data set. Then, a function provides the accuracy as a function of the training sampling rate and the test sampling rate. FIGS. 8A-C illustrate this function further. This evaluation can be performed a priori to determine the function. In the storage system, then correct model can be chosen based on a current sampling rate. Then, the sampling rate in CSD can be adjusted to match the selected model.

In some embodiments, the model can be trained by a model training computer or cloud computer receiving a plurality of I/O operations. The model training computer or cloud computer can use feature information that had been extracted from I/O operations with different sampling rates. Alternatively, the model training computer or cloud computer can sample those I/O operations at different sampling rates from collected I/O operation traces. The model training computer or cloud computer can train a plurality of models on each of those sampling rates and corresponding extracted features.

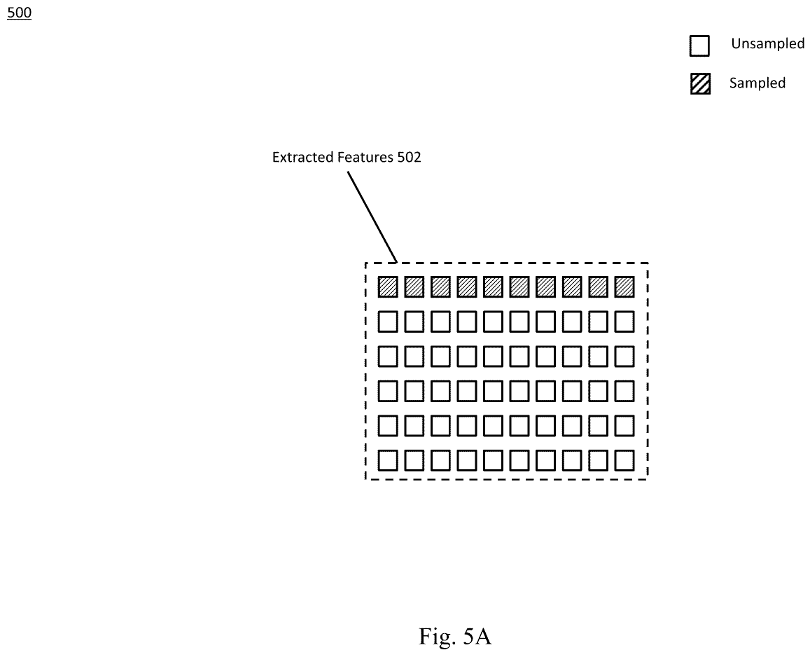

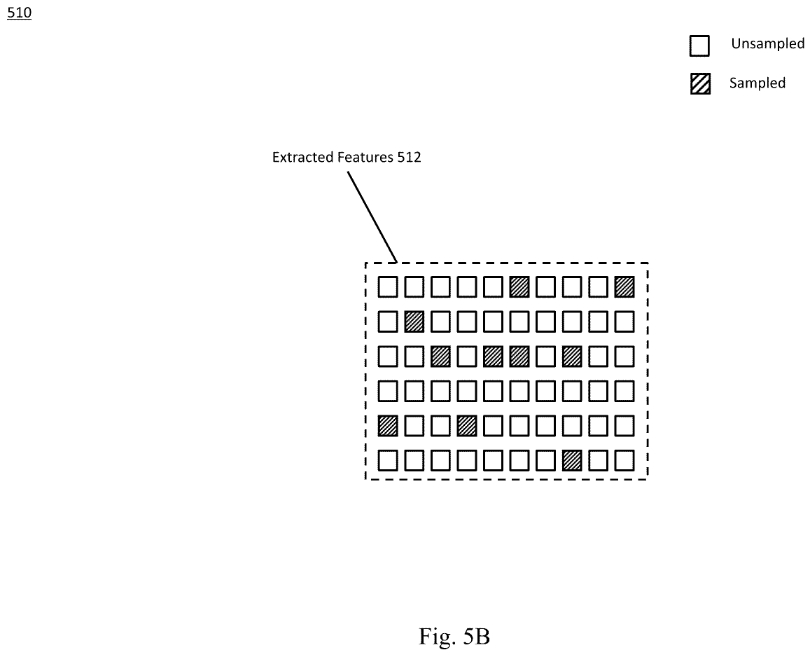

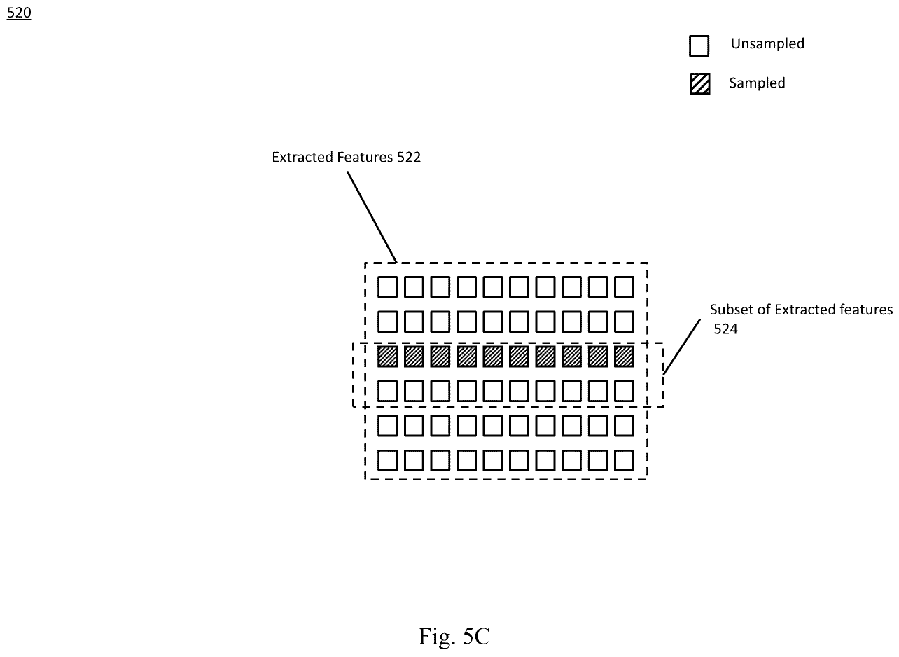

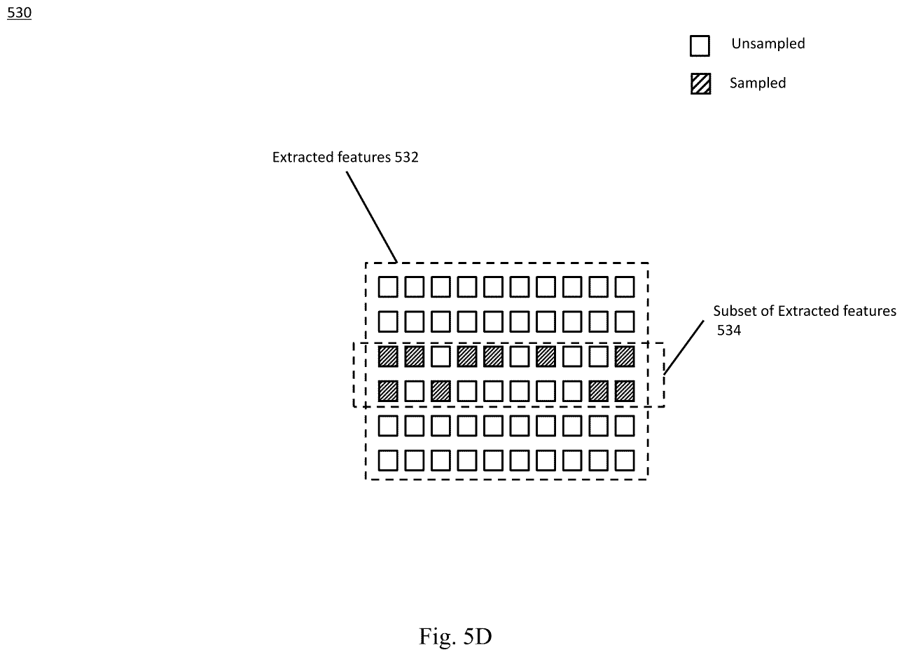

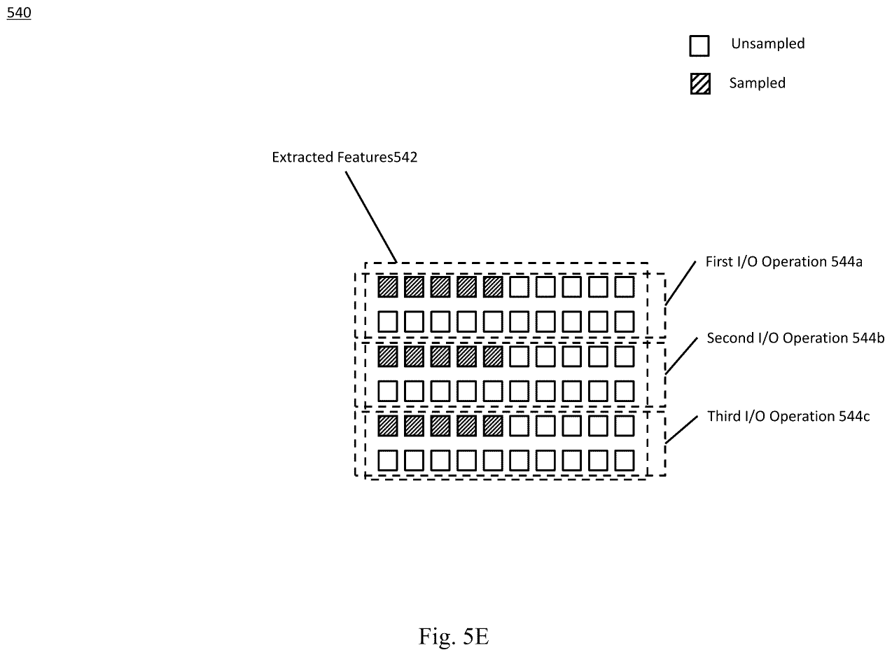

The sampling settings 310 can include the sampling rate (e.g., a percentage Y, or Y %, of the stream) and a sampling method. Sampling rates and sampling methods are described further below in relation to FIG. 5A-E. Referring again to FIG. 3, the model training module 308 outputs a trained model 314, the trained model configured to output an accuracy metric when provided sample settings.

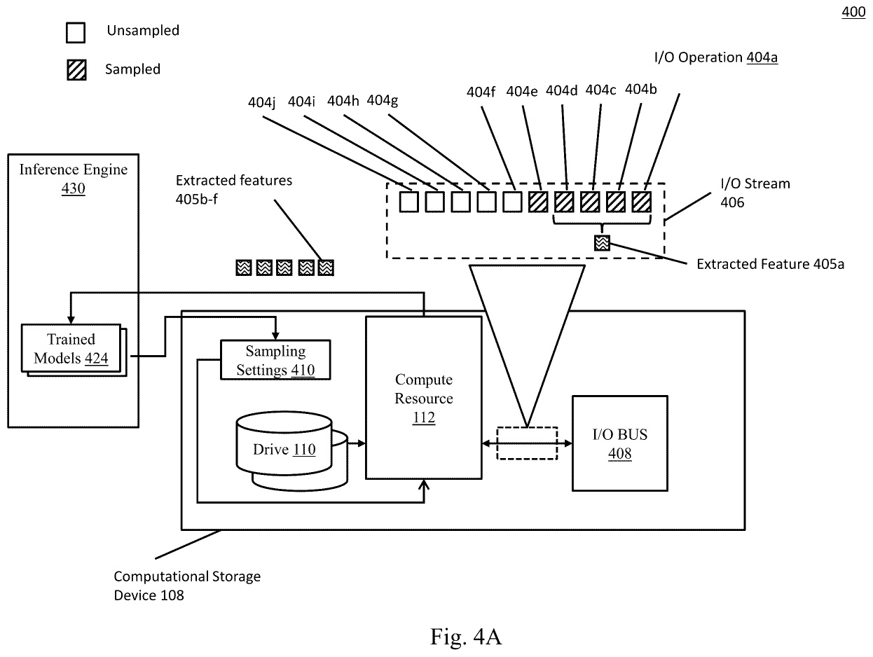

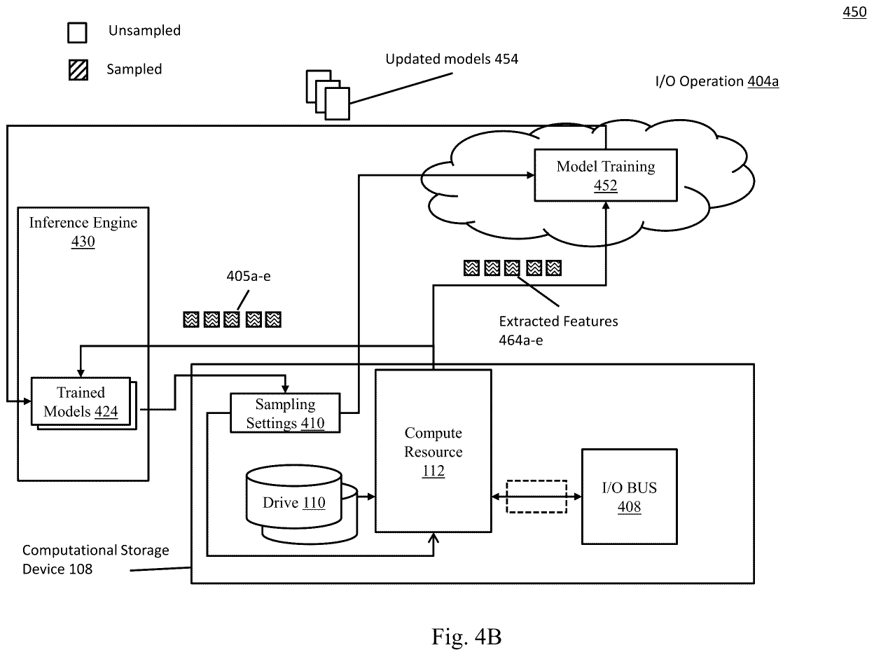

FIG. 4A is a block diagram 400 illustrating a computational storage device 108 sampling from an I/O stream 406 to use trained machine learning models 424 at an inference engine 430 (e.g., of an all flash array or other higher layer) according to embodiments of the present disclosure. The trained models 424 can be trained using the system and corresponding method of FIG. 3.

In some embodiments, the compute resource 112 of the CSD 108 samples I/O operations from the I/O Stream 406 when there is a high I/O rate, thereby providing a set of extracted features 405a-f. In some embodiments, the compute resource 112 samples the I/O Operations 404a-404j using a sampling rate and sampling method of sampling settings 416. It can be recognized that in some embodiments, the I/O Bus 408 includes a compute resource that performs the sampling in a similar manner. In FIGS. 3-5E, features extracted from sampled operations are illustrated as chevron-patterned blocks, while sampled I/O operations are illustrated as striped blocks and unsampled operations are illustrated as blank boxes.

The compute resource 112 can sample the I/O operations 404a-j to extract features 404a-f from the I/O Stream 406. The collection of trained models can receive extracted features 404a-f from the compute resource. In some embodiments, the extracted features 404a-f are extracted from the I/O stream. In some embodiments, the compute resource 112 samples or extracts features from the I/O stream at multiple sample rates, thereby providing the trained models 424 with multiple sample rates to test.

The collection of trained models can output an optimal sampling setting 410 to be employed by the compute resource 112, based on scores, such as an F1 score, provided by each model in response to the provided extracted features. In response, the I/O Bus 408 can adopt the sampling settings 410 if the compatibility metric 416 is above a threshold. In some embodiments, the inference engine 430 with the trained model resides within the storage system stack 170 of FIG. 1B. In some embodiments, compatibility metrics are controlled by the storage system stack 170 of FIG. 1B. The storage system stack 170 of FIG. 1B further stores the sampling settings and issues commands to adjust the sampling rate on the CSDs when needed.

The extracted features 405a-f, having been sampled with the updated sampling settings 410, can be provided to the compute resource 112. The sampling settings 410 can include the sampling rate (e.g., a percentage Y, or Y %, of the stream) and a sampling method. Sampling rates and sampling methods are described further below in relation to FIG. 5A-E.

The compute resource 112 can direct the models 424 to generate a score for multiple sampling rates and multiple sampling methods for each of those rates. The compute resource 112 can then select a highest compatibility metric, and select a sampling setting 410 (e.g., a sampling rate and a sampling method) associated with that metric. That sampling setting can then be used to sample I/O operations 404a-j to collect a set of sampled I/O operations 404a-e.

FIG. 4B is a block diagram 400 illustrating a computational storage device 108 sampling from an I/O stream 406 to train and use multiple trained machine learning models according to embodiments of the present disclosure. A model training module 452 receives extracted feature information 464a-e obtained from sampled I/O operations and trains the ML models 424 in the manner described above in relation to FIGS. 3-4A. In relation to FIG. 4B, the ML models 424 can then output sampling settings 410 in the manner described by FIG. 4A. In relation to FIG. 4B, the sampling settings 410 can then be provided to a model training module 452 (e.g., executed by one or more processors of a cloud server), thereby updating the trained models 424. In this manner, the ML models 424 can iteratively and/or continuously re-train the models 424 and update the sampling settings 410 using those models, thereby providing the inference engine 430 with updated models 454 that can replace or update the trained models 424.

Sampling, however, can be performed by multiple methods, and the method of sampling can affect accuracy for different applications. In some embodiments, the method and corresponding system disclosed herein can identify an optimal sampling technique for a specific I/O sampling rate by training and then using a machine-learning model.

In some embodiments, the method can select a sampling method for sampling I/O requests or operations. In some embodiments, the sampling methods can include sequential, random, sequential-chunk, random-chunk, and I/O-aware, however, other sampling methods may be employed. The sampling methods are described further below in relation to a buffer of I/O operations having length X and a sampling rate (e.g., sampling percentage target) of Y %.

FIG. 5A is a diagram 500 illustrating an example of sequential sampling according to embodiments of the present disclosure. In some embodiments, sequential sampling methods retrieve a first Y % of the X operations of the input buffer, and the rest of the operations are dropped. FIG. 5A illustrates extracted features 502 extracted from sampled operations (shown in stripes) at as the first Y % of the operations in the I/O stream 502 or input buffer. In some embodiments, the extracted features 502 can be a portion of features that are extracted from a set of features.

FIG. 5B is a diagram 510 illustrating an example of random sampling according to embodiments of the present disclosure. In some embodiments, random sampling retrieves Y % of X at random from the input buffer, and the rest operations are dropped. FIG. 5B illustrates an extracted 512 having extracted features (shown in stripes) at as a randomly selected Y % of the features 512 or input buffer.

FIG. 5C is a diagram 520 illustrating an example of sequential-chunk sampling according to embodiments of the present disclosure. In some embodiments, sequential-chunk sampling retrieves a first Y % of a subset 524 of length X of the features 522, and the rest of the features are dropped. The subset can have length Z. The subset can begin at any position within the input buffer. Z can be a parameter to be evaluated. In some embodiments, the ML can be trained using the value of Z as an additional parameter. FIG. 5C illustrates an I/O stream 522 having features (shown in stripes) at as the first Y % of the subset 524 of features.

FIG. 5D is a diagram 530 illustrating an example of random-chunk sampling according to embodiments of the present disclosure. In some embodiments, random-chunk sampling retrieves Y % of a subset 534 of the features 532 or input buffer at random, and the rest of the operations are dropped. The subset 534 of the features 532 can have a length Z. In some embodiments, the ML can be trained using the value of Z as an additional parameter. FIG. 5D illustrates features 532 having sampled features (shown in stripes) at as a random Y % of the operations of the subset 534.

FIG. 5E is a diagram 540 illustrating an example of I/O-aware sampling according to embodiments of the present disclosure. In some embodiments, I/O-aware sampling retrieves a first Y % of an I/O operation 544a-c of the input buffer, and the rest operations are dropped. In some embodiments, the I/O operation is a unique I/O operation. For example, a system-level I/O operation of 128 KB can result in (e.g., be broken down into) 32 4 KB I/O operations in the CSD. The 4 KB operation can be considered a single I/O operation or a unique I/O operation. At the CSD-level, size of a R/W operation can be known, and therefore the CSD can track the continuation of the operation. Therefore, I/O-aware sampling retrieves at least one I/O operation of each system-level operation at the CSD. In some embodiments, and depending on the value of Y %, extracted features from more than one CSD-level operations can be sampled, especially for longer system-level I/O operations. I/O-aware sampling can represent every system I/O operation in the training data, and therefore not lost or corrupted due to random or sequential order. FIG. 5D illustrates an extracted features 542 having sampled features (shown in stripes) at as the first Y % of each respective operations 544a-c of the extracted features 542.

In some embodiments, the method and corresponding system described herein enhances the efficiency and accuracy of ransomware detection without overburdening the CSD's processing capabilities. This results in better resource utilization, improved security features, and a more robust storage solution that can adapt dynamically to varying I/O rates.

In addition, a computational storage devices (CSD) implementing ransomware detection (RWD) performs feature extraction of I/O operations and aggregation of the extracted features in regular time intervals. Above a certain I/O rate, or when the number of collected features increases, the CSD will no longer be able to process all I/O requests due to the limited computational performance of the processor. At these high I/O rates, the CSD will have to sample I/O requests. This will impact the statistics of the aggregated features. When training and inference is not done with the same (or similar) sampling frequencies, significant drop in detection accuracy has been observed.

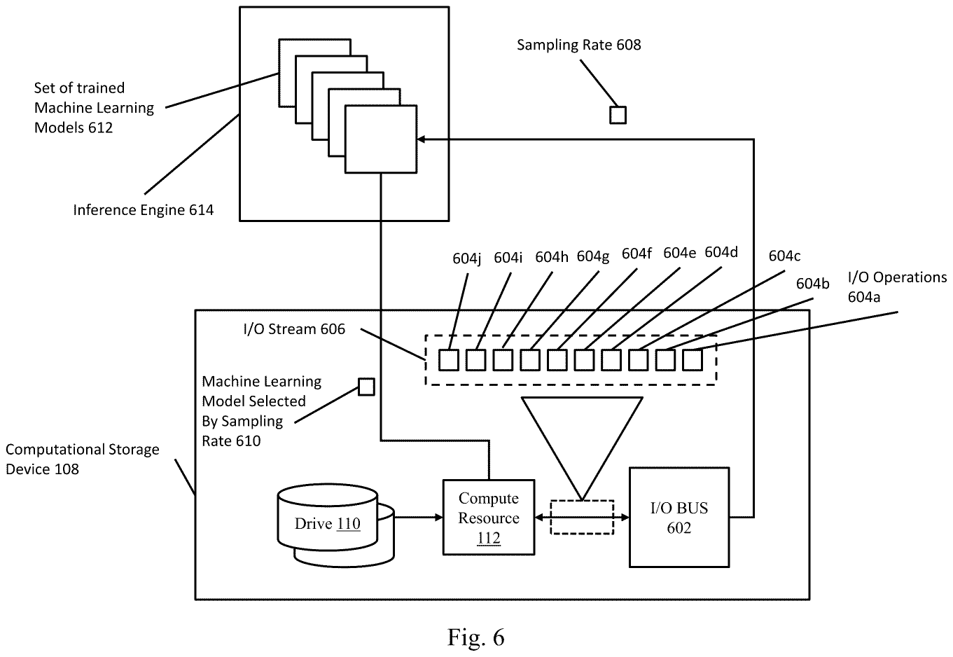

FIG. 6 is a block diagram 600 illustrating an example embodiment of a computational storage device 108 and inference engine 614 determining optimal sampling frequency of I/O request for ransomware detection according to embodiments of the present disclosure. In some embodiments, a method and corresponding system disclosed herein matches a sampling rate 608 (e.g., a sampling frequency) of I/O operations 604a-j of an I/O stream 606 being collected for inference with a sampling rate or sampling rate used to train the set of ML model(s) 612. In some embodiments, the inference engine 614 stores the set of trained ML models 612. However, the CSD 108 can store the models 612 in some embodiments. Each model of the set 612 is trained on, and therefore associated with, a different sampling rate or sampling rate range. Additional sets of models may be trained with different sampling methods as well.

The CSD 108 can provide a sampling rate 608 to the machine learning models 612. In some embodiments, the CSD 108 can provide the sampling of the I/O stream 606 that corresponds with the sampling rate 608 to the machine learning models 612. In some embodiments, the CSD 108 can provide multiple sampling rates 608 and multiple samplings of the I/O stream 606 corresponding to each of those rates to the machine learning models 612. The inference engine 614 (e.g., of the all-flash array) can then match the sampling rate 608 of the I/O operations 604a-j to that of one of the set of ML models 612. Matching the sampling rate 608 can comprise an exact match to the associated sampling rate of one of the models, a match to the associated sampling rate of one of the models within a threshold percentage, a match to an associated sampling rate range of one of the models, etc. In some embodiments, the sampling rate 608 can be determined based on observing the rate of I/O operations at the I/O Bus 602 (e.g., an average, a moving average, etc.), or using current workload of the I/O Bus 602 or compute resource 112.

In some embodiments, the CSD 108 can store a single model (e.g., the set of trained machine learning models 612 is one model). In some embodiments, the compute resource 112 of the CSD 108 determines the sampling rate 608 is at full speed of the I/O bus 602. In some embodiments, the full sampling rate 608 can be determined during development or testing of the models. The ML model can be trained using traces that have been collected with the same, or similar, maximum sampling rate. The determined sampling rate 608 is employed by the CSD when the I/O rate is lower than the maximum rate. Hence, a fixed common I/O sampling rate 608 (e.g., the maximum sampling rate) for training and inference is used when there is one machine learning model in the set.

In some embodiments, the system and method can determine acceptable ranges of sampling rates for the set of trained ML-models 612. For example, when the sampling rate 608 is low, a model having a slightly higher sampling rate can be selected from the set of trained ML models 612 to extract more feature information.

In some embodiments, each ML model of the set of ML models 612 can correspond or be associated with a storage volume that is stored on one or more drives 110 of a plurality of drives (e.g., volumes provided by a RAID array). In some embodiments, an ML model 612 that is associated with a volume is trained on I/O operations directed to that drive.

In some embodiments, the method and system described herein can improve accuracy of the models and enables collection of more features (e.g., for ransomware detection).

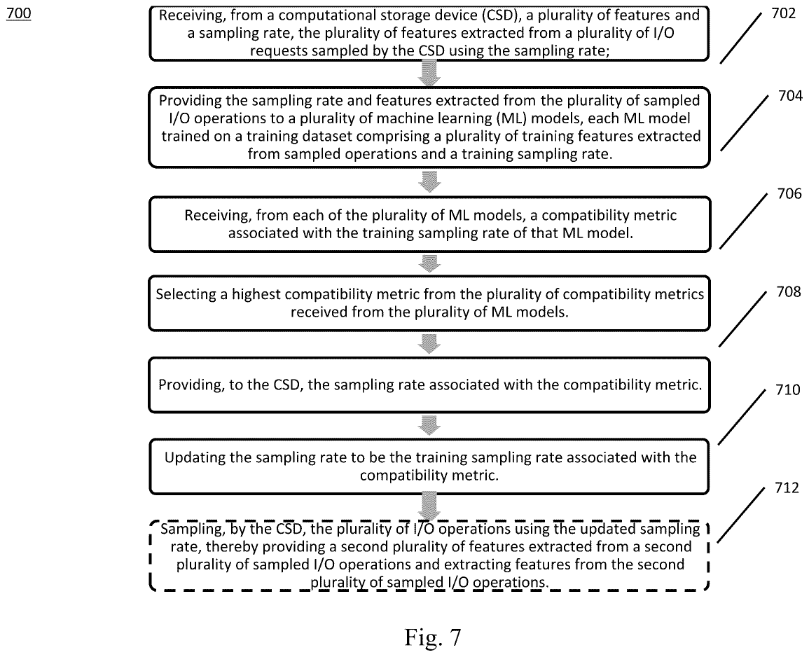

FIG. 7 is a flow diagram 700 illustrating a process of adjusting a sampling rate at a CSD according to embodiments of the present disclosure. The process can comprise receiving, from a computational storage device (CSD), a plurality of features and a sampling rate, the plurality of features extracted from a plurality of I/O requests sampled by the CSD using the sampling rate. (702). The process can comprise providing the sampling rate and the first plurality of features extracted from the first plurality of sampled I/O operations to a plurality of machine learning (ML) models (704). Each ML model can be trained on a training dataset comprising a plurality of features extracted from a plurality of training sampled operations, a training sampling rate. The process can comprise receiving, from each of the plurality of ML models, an compatibility metric associated with the training sampling rate of that ML model and the sampling rate used when executing inference with the test data set (706). The process can comprise selecting a highest compatibility metric from the plurality of compatibility metrics received from the plurality of ML models (708). The process can comprise updating the sampling rate to be the training sampling rate associated with the compatibility metric (710). Optionally, the process can comprise sampling, by the CSD, the plurality of I/O operations using the updated sampling rate, thereby providing a second plurality of features extracted from a second plurality of sampled I/O operations (712), and can also optionally comprise extracting features from the second plurality of sampled I/O operations.

FIG. 8A is a graph 800 illustrating F1 scores of a model trained without sampling using an inference on a test set with a varying sampling rate according to embodiments of the present disclosure. The graph 800 illustrates F1 score as a function of sampling rate for inference with the test set. The model is trained on the original trace and the inference is performed with a sampled trace at a fixed sampling ratio. The F 1 score drops below the threshold of 0.94 at lower sampling rates due to the sampling as illustrated by the graph 800.

FIG. 8B is a graph 820 illustrating F1 scores of a model and testing data that use the same sampling rate according to embodiments of the present disclosure. The graph 800 illustrates F1 score as a function of sampling rate for both training and inference (test) tests. The graph 800 illustrates that the F1 score is above the threshold of 0.94 for most sampling rates. The F1 score is below the threshold for lower sampling rates because there are not enough IO requests in the measurement interval for those sampling rates.

FIG. 8C is a graph 840 illustrating F1 scores of a model trained with a fixed sampling rate and an inference on test set with varying sampling rate according to embodiments of the present disclosure. In this example graph 800, the fixed sampling rate of the model is 1%. The F1 score is at a maximum when the sampling rate of the inference is around the sampling rate during training. The F1 score drops when the sampling rate of inference is greater than or less than the sampling rate during training.

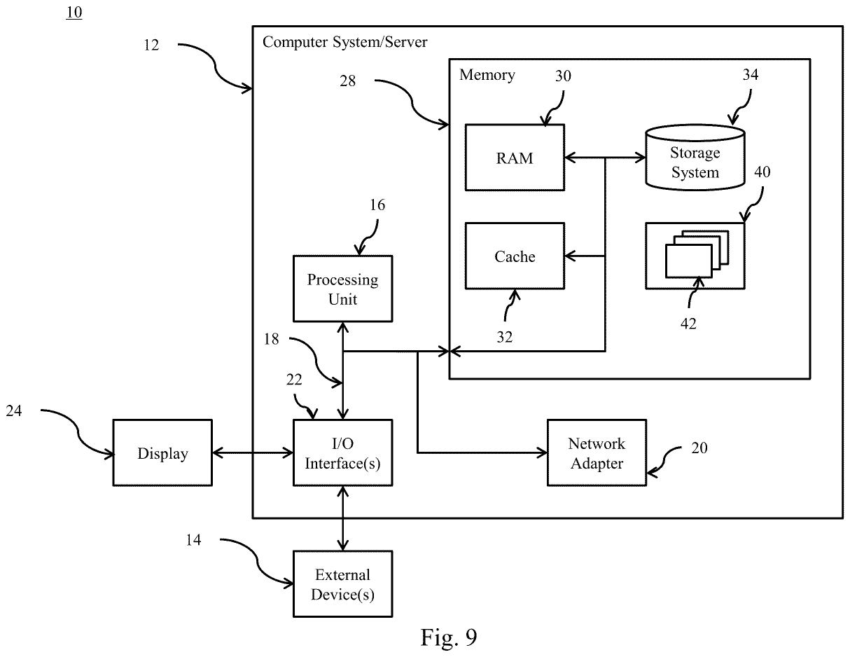

Referring now to FIG. 9, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method to determine a sampling frequency of input/output (I/O) requests for ransomware detection, the method comprising:
receiving, from a computational storage device (CSD), a plurality of features and a sampling rate, the plurality of features extracted from a plurality of I/O requests sampled by the CSD using the sampling rate;
providing the sampling rate and the plurality of features to a plurality of machine learning (ML) models, each ML model trained on a training dataset comprising a plurality of training sampled operations and a training sampling rate;
receiving, from each of the plurality of ML models, a compatibility metric associated with the training sampling rate of that ML model;
selecting a highest compatibility metric from the plurality of compatibility metrics received from the plurality of ML models; and
providing, to the CSD, the sampling rate associated with the compatibility metric.

2. The method of claim 1, further comprising:
sampling, by the CSD, the plurality of I/O operations using the updated sampling rate, thereby providing a plurality of sampled I/O operations.

3. The method of claim 2, further comprising:
extracting features from the plurality of sampled I/O operations.

4. The method of claim 3, further comprising:
providing the extracted features to an inference engine to generate a prediction of ransomware based on the extracted features.

5. The method of claim 1, wherein the training sampling rate of each ML model is a range of sampling rates.

6. The method of claim 1, wherein each ML model of the plurality of ML model is associated with a storage volume of the CSD.

7. The method of claim 1, wherein each of the plurality of ML models is further trained based on a workload of the CSD.

8. A system comprising:
a computing node comprising a computer readable storage medium having program instructions embodied therewith, the program instructions executable by a processor of the computing node to cause the processor to perform a method comprising:
receiving, from a computational storage device (CSD), a plurality of features and a sampling rate, the plurality of features extracted from a plurality of I/O requests sampled by the CSD using the sampling rate;
providing the sampling rate and the plurality of sampled I/O operations to a plurality of machine learning (ML) models, each ML model trained on a training dataset comprising a plurality of training sampled operations and a training sampling rate;
receiving, from each of the plurality of ML models, a compatibility metric associated with the training sampling rate of that ML model;
selecting a highest compatibility metric from the plurality of compatibility metrics received from the plurality of ML models; and
providing, to the CSD, the sampling rate associated with the compatibility metric.

9. The system of claim 8, wherein the method executed by the processor further comprises:
sampling, by the CSD, the plurality of I/O operations using the updated sampling rate, thereby providing a second plurality of sampled I/O operations.

10. The system of claim 9, wherein the method executed by the processor further comprises:
extracting features from the second plurality of sampled I/O operations.

11. The system of claim 10, wherein the method executed by the processor further comprises:
providing the extracted features to an inference engine to generate a prediction of ransomware based on the extracted features.

12. The system of claim 8, wherein the training sampling rate of each ML model is a range of sampling rates.

13. The system of claim 8, wherein each ML model of the plurality of ML model is associated with a storage volume of the CSD.

14. The system of claim 8, wherein each of the plurality of ML models is further trained based on a workload of the CSD.

15. A computer program product for sampling data at a storage system, the computer program product comprising a computer readable storage medium having program instructions embodied therewith, the program instructions executable by the storage system to cause the storage system to perform a method comprising:
receiving, from a computational storage device (CSD), a plurality of features and a sampling rate, the plurality of features extracted from a plurality of I/O requests sampled by the CSD using the sampling rate;
providing the sampling rate and the plurality of sampled I/O operations to a plurality of machine learning (ML) models, each ML model trained on a training dataset comprising a plurality of training sampled operations and a training sampling rate;
receiving, from each of the plurality of ML models, a compatibility metric associated with the training sampling rate of that ML model;
selecting a highest compatibility metric from the plurality of compatibility metrics received from the plurality of ML models; and
providing, to the CSD, the sampling rate associated with the compatibility metric.

16. The computer program product of claim 15, wherein the method executed by the processor further comprises:
sampling, by the CSD, the plurality of I/O operations using the updated sampling rate, thereby providing a second plurality of sampled I/O operations.

17. The computer program product of claim 16, wherein the method executed by the processor further comprises:
extracting features from the second plurality of sampled I/O operations.

18. The computer program product of claim 17, wherein the method executed by the processor further comprises:
providing the extracted features to an inference engine to generate a prediction of ransomware based on the extracted features.

19. The computer program product of claim 15, wherein the training sampling rate of each ML model is a range of sampling rates.

20. The computer program product of claim 15, wherein each ML model of the plurality of ML model is associated with a storage volume of the CSD.
